(19) United States
(12) Patent Application Publication
(10) Pub. No.: US 2009/0049463 A1
(43) Pub. Date: Feb. 19, 2009

(54) MOTOR DRIVING DEVICE, AND MOTOR DRIVING METHOD

(76) Inventor: Ryuji Ueda, Osaka (JP)

Correspondence Address: MCDERMOTT WILL & EMERY LLP, 600 13TH STREET, NW, WASHINGTON, DC, 20005-3096, US

(21) Appl. No.: 12/279,428

(22) PCT Filed: Feb. 23, 2007
(86) PCT No.: PCT/JP2007/053404

§ 371 Date: Aug. 14, 2008

(30) Foreign Application Priority Data
Feb. 23, 2006 (JP) 2006-046501

(51) Int. Cl. G11B 17/028; H02P 6/14

(52) U.S. Cl. 720/695; 318/400.15; G9B/17.006

(57) ABSTRACT

A motor driving device generates a first PWM control signal for PWM driving each phase (1u, 1v, 1w) of stator windings of a motor (1) and a second PWM control signal for synchronously rectifying the phases (1u, 1v, 1w) on the basis of a current command signal indicating the level of a current to be supplied to the motor (1) and a phase current signal indicating the level of a current actually supplied to the motor (1) and drives the motor (1) according to the first and second PWM control signals. The motor driving device includes a synchronous rectification control switching section (21) for controlling the presence or absence of a mask for the second PWM control signal according to a provided control switching signal.

### TECHNICAL FIELD

The present invention relates to a motor driving device and a motor driving method for stable control on low-speed drive.

### BACKGROUND ART

Recently, brushless DC motors for driving a medium, such as an optical disc are demanded to have highly stable controllability on low speed rotation in a function of media rendering and the like. A PWM driving scheme is often employed for driving a three-phase brushless DC motor. In PWM drive, a scheme generally-called synchronous rectification control is employed in many cases in which power transistors are driven so that motor windings and the power transistors in an ON state form a closed circuit when a power source current is not supplied to the motor windings, namely, in a regeneration state. The synchronous rectification control allows the regeneration current to flow in a reflux diode which is connected to the power transistors in parallel to exhibit an effect of suppressing power consumption in the reflux diode and is therefore effective in increasing the efficiency of the PWM drive.

FIG. 20 shows a construction of a conventional driving device for a brushless DC motor, which is called of 120-degree conduction peak current detection type. In FIG. 20, reference numeral 1 denotes a three-phase brushless DC motor (hereinafter referred to it merely as a motor), 1u, 1v, 1w denote stator windings for three phases of the motor 1, 2a, 2b, 2c denote three position sensors for detecting the position of a rotor of the motor 1, 3 denotes a position detection signal amplification section for amplifying position detection signals, 4 denotes a current command signal generation section for outputting a current command signal TQ, 5 denotes a current detection resistor, 6 denotes a phase current signal amplification section for outputting a phase current signal D, 7 denotes a comparator for comparing the current command signal TQ and the phase current signal D, 8 denotes an oscillation section for generating a PWM frequency, 9 denotes a PWM control section composed of a flip-flop circuit 91 and a PWM control signal generating circuit 92, 10 denotes a conduction control section, 11 denotes a power transistor section which is composed of half-bridge circuits connected in parallel and in which reflux diodes are connected in parallel to power transistors, and 12 denotes an external torque command input terminal.

The thus constructed driving device for a brushless DC motor and its operation will be described below with reference to FIG. 20.

The current command signal generation section 4 is a circuit for receiving a torque command signal and generating a command signal of currents to be applied to the stator windings 1u, 1v, 1w of the motor 1 and generates, upon reception of the torque command signal TQ0 to the motor 1, a current command signal TQ as an output signal of the current command signal generation section 4. The current detection resistor 5 detects as a voltage currents flowing in the stator windings 1u, 1v, 1w of the motor 1. The phase current signal amplification section 6 amplifies a signal detected by the current detection resistor 5 and outputs the amplified one as a phase current signal D.

The comparator 7 compares the current command signal TQ generated in the current command signal generation section 4 and the phase current signal D output from the phase current signal amplification section 6 and outputs a comparison result as a reset pulse signal B. The oscillation section 8 generates a set pulse signal A for periodically switching the power transistor section 11.

The flip-flop 91 of the PWM control section 9 generates a pulse signal C that is set upon reception of the set pulse signal A from the oscillation section 8 and is reset upon reception of the reset pulse signal B output from the comparator 7.

A schematic construction of the PWM control signal generating circuit 92 of the PWM control section 9 is shown in FIG. 21. The PWM control signal generating circuit 92 is composed of a delay circuit 921 and logic elements 922, 923. The delay circuit 921 provides a predetermined delay time to a rise edge and a fall edge of the pulse signal C and may be composed of a CR circuit or a logic circuit. From the pulse signal C, the PWM control signal generating circuit 92 generates two PWM control signals of a PWM drive signal (pwm signal) and a synchronous rectification drive signal (pwmSYNC signal) corresponding thereto for synchronous rectification control, which are used for driving source side (upper) transistors and sink side (lower) transistors, respectively, of the power transistor section 11. A dead time for preventing a current from passing vertically through the source side transistors and the sink side transistors forming the output of the power transistor section 11 is provided between edges of each of the pwm signal and the pwmSYNC signal.

FIG. 22 shows the set pulse signal A, the reset pulse signal B, the pulse signal C, and the PWM drive signal (the pwm signal) and the synchronous rectification drive signal (the pwmSYNC signal) generated from the pulse signal C. In FIG. 22, reference DT denotes the dead time for preventing the current from passing vertically through the power transistor section 11.

The position sensors 2a, 2b, 2c shown in FIG. 20 detect the position detection signals according to the rotation position of the rotor. The position detection signals are amplified in the position detection signal amplification section 3 and are output to the conduction control section 10.

The conduction control section 10 determines, upon reception of the position detection signals PU, PV, PW of the rotors output from the position detection signal amplification section 3, to which stator winding 1u, 1v, or 1w of the motor 1 power is to be supplied, and generates, upon reception of the PWM control signals generated in the PWM control section 9, a conduction control signal for PWM driving the power transistor section 11. The power transistor section 11 supplies the source power to the stator windings 1u, 1v, 1w of the motor 1 for PWM drive upon reception of the conduction control signal. FIG. 23 shows the phase relationship among the position detection signals PU, PV, PW generated in the position detection signal amplification section 3, the respective phase current waveforms of the stator windings of the motor 1, and the driving states of the power transistors.

Thus, the three-phase brushless DC motor is driven (see Patent Documents 1 and 2, for example).

### Patent Document 1: Japanese Unexamined Patent Application Publication 2003-174789

### Patent Document 2: Japanese Unexamined Patent Application Publication 5-211780

### SUMMARY OF THE INVENTION

### Problems that the Invention is to Solve

In the conventional motor driving method according to the peak current detection scheme, however, large potential difference is caused transiently at each terminal of the current detection resistor 5 when a power transistor is turned ON to supply power to a stator winding of the motor 1. This potential difference always appears in PWM drive to cause the comparator 7 to operate and output the reset pulse B, thereby stopping conduction of the power transistor section 11. Accordingly, the currents in the stator windings cannot be controlled.

In order to overcome this disadvantage, a current detection inhibiting period of a predetermined period is provided in the PWM control section 9 in the conventional peak current detection type motor driving method. With the current detection inhibiting period provided, the power supplied to the stator windings cannot have a pulse width equal to or smaller than the minimum pulse width governed in the current detection inhibiting period. For this reason, minimization of the value of the torque command signal cannot make the current flowing in the stator windings of the motor 1 to be equal to or lower than the current determined by the duty ratio according to the PWM frequency and the minimum pulse width, resulting in restriction on the lowest rotation speed of the motor 1.

The above phenomenon will be described below in detail. FIG. 24 shows waveforms for PWM control in motor drive by a minute torque command and shows the PWM drive of an arbitrary one phase of the stator windings of the motor. In FIG. 24, reference A denotes the set pulse signal generated in the oscillation section 8 shown in FIG. 20, B denotes a reset pulse signal output from the comparator 7, and C denotes the pulse signal of the PWM control section 9. The set pulse signal A is a signal indicating start of power supply to the stator windings of the motor, and the reset pulse signal B is a signal indicating stop of the power supply to the stator windings of the motor.

The PWM control section 9 shown in FIG. 20 generates the pulse signal C indicating an conduction period of the power transistors from the set pulse signal A and the reset pulse signal B. The pulse signal C is in ON state or OFF state. The ON state means a state that power is supplied to one of the stator windings of the motor 1 while the OFF state means a state that the power supply to the stator winding is stopped. Wherein, the OFF state does not mean complete stop of the power supply to the stator winding and means a state allowing the regeneration current from another stator winding of the motor 1 to flow, thereby gradually stopping the power supply to the stator winding. In this OFF state, the current supplied to the stator winding does not flow into the current detection resistor 5.

The PWM control signal generating circuit 92 of the PWM control section 9 generates the PWM control signals (the pwm signal and the pwmSYNC signal) from the pulse signal C, which are not shown in FIG. 24. The current command signal TQa indicates a given torque command state of the current command signal TQ generated in the current command signal generation section 4 in FIG. 20. Similarly, the phase current signal Da is the phase current signal D output from the phase current signal amplification section 6 in FIG. 20 and indicates a state according to the aforementioned given torque command state TQa.

At a timing t1 when the pulse signal C shown in FIG. 24 is switched from the OFF state to the ON state, large noise voltage is generated in the phase current signal Da owing to a parasitic element or the like of the driving device. In order to prevent the noise voltage from being input to the comparator in FIG. 20, which causes malfunction, the current detection inhibiting period for a predetermined period is provided after the set pulse signal A is applied in the conventional driving device shown in FIG. 20. In FIG. 24, the period when the set pulse signal A is “L” corresponds to the current detection inhibiting period Tn. When the set pulse signal A is “L,” the reset pulse signal B is ignored so that the pulse signal C remains “H” in this period even if the reset pulse signal B is “L” to allow the ON state of the PWM control to continue.

In periods t1 to t3 in which the current command signal TQa is comparatively large, the phase current signal D reaches the current command signal TQa at t3. In this case, since the reset pulse signal B is output at t3 after the current detection inhibiting period Tn, the pulse signal C is switched at t3 from the ON state to the OFF state.

On the other hand, in periods t4 to t6 in which the current command signal TQa is comparatively small, the set pulse signal B is “L” to set the pulse signal C to be in the ON state at t4, and the phase current signal Da reaches the current command signal TQa at t5. At the time of t5, which is in the current detection inhibiting period where the set pulse signal A is “L,” the reset pulse B is ignored to allow the pulse signal C to remain in the ON state. At this time point, the reset pulse signal B is kept in “L” state. At the timing t6 when the current detection inhibiting period Tn is released, the set pulse signal A is “H” and the reset pulse signal B is recognized to set the pulse signal C to be in the OFF state.

Accordingly, the minimum pulse width of the pulse signal C will not become smaller than that in the current detection inhibiting period Tn. For this reason, the current supplied to the stator windings of the motor cannot be set lower than the current value conducted at the minimum pulse width of the pulse signal C, and the torque generated in the motor 1 cannot be lower than a predetermined value even if the current command signal TQa is lowered. As a result, the lowest rotation speed of the motor 1 is restricted.

The present invention has been made for solving the above problems in the background art and has its object of providing a motor driving device and a motor driving method which extend a low-rotation controllable range by reducing the lowest rotation speed of motor drive in low-speed rotation control.

### Means for Solving the Problems

To attain the above object, a motor driving device in accordance with the present invention is a motor driving device which generates a first PWM control signal for PWM driving each phase of stator windings of a motor and a second PWM control signal for synchronously rectifying the phases on the basis of a current command signal indicating a level of a current to be supplied to the motor and a phase current signal indicating a level of a current actually supplied to the motor and drives the motor according to the first and second PWM control signals, the motor driving device including a synchronous rectification control switching section for controlling the presence or absence of a mask for the second PWM control signal according to a provided control switching signal. A motor driving method in accordance with the present invention is a motor driving method in which a first PWM control signal for PWM driving each phase of stator windings of a motor and a second PWM control signal for synchronously rectifying the phases are generated on the basis of a current command signal indicating a level of a current to be supplied to the motor and a phase current signal indicating a level of a current actually supplied to the motor for driving the motor according to the first and second PWM control signals, wherein the second PWM control signal is masked when the motor is driven at low speed and is unmasked when the motor is driven at high speed.

With the above arrangement or method, the synchronous rectification control state is switched to the synchronous rectification non-control state when low-speed control on the motor is desired to reduce the amount of currents flowing into the stator windings of the motor, thereby attaining drive control on the motor in a low speed range.

Preferably, the motor driving device in accordance with the present invention further includes: a rotation speed signal generation section for generating a rotation speed signal indicating a rotation speed of the motor; and a control switching signal generation section for generating the control switching signal on the basis of the rotation speed signal. Alternatively, the motor driving device in accordance with the present invention further includes: a current command signal generation section for generating the current command signal from a torque command signal indicating a torque command to the motor; and a control switching signal generation section for generating the control switching signal on the basis of one of the torque command signal and the current command signal. Or, the motor driving device in accordance with the present invention includes the current command signal generation section, the rotation speed signal generation section, and a control switching signal generation section for generating the control switching signal on the basis of the rotation speed signal and either the torque command signal or the current command signal. Alternatively, the motor driving device in accordance with the present invention further includes a rotation speed signal generation section for generating a rotation speed signal indicating a rotation speed of the motor, wherein the control switching signal generation section generates the control switching signal on the basis of the rotation signal.

As well, preferably, in the motor driving method in accordance with the present invention, the second PWM control signal is masked when a rotation speed of the motor is lower than a threshold value and is unmasked when the rotation speed of the motor is higher than the threshold value. Alternatively, in the motor driving method in accordance with the present invention, the second PWM control signal is masked when a torque commanded to the motor is lower than a threshold value and is unmasked when the torque is higher than the threshold value. Or, in the motor driving method in accordance with the present invention, the second PWM control signal is masked when both a rotation speed of the motor and a torque commanded to the motor are lower than respective threshold values and is unmasked when at least one of the rotation speed and the torque is higher than the corresponding threshold value. Alternatively, in the motor driving method in accordance with the present invention, the second PWM control signal is unmasked when both a rotation speed of the motor and a torque commanded to the motor are higher than respective threshold values and is masked when at least one of the rotation speed and the torque is lower than the corresponding threshold value. Alternatively, the motor driving method in accordance with the present invention includes the step of: generating the current command signal by amplifying a torque command signal indicating a torque command to the motor; and changing a gain for the amplification according to the presence or absence of a mask for the second PWM control signal.

With the above arrangements or methods, switching between the synchronous rectification control state and the synchronous rectification non-control state can be carried out automatically.

### EFFECTS OF THE INVENTION

According to the present invention, when the low speed control on a three-phase brushless DC motor or the like is desired, the synchronous rectification control state is switched to the synchronous rectification non-control state to reduce the amount of the currents flowing into the stator windings of the motor. Thus, in the low speed range of the motor, a rotation irregularity is reduced and highly accurate low-rotation control is attained.

### BRIEF DESCRIPTION OF THE DRAWINGS

FIG. 1 is a diagram showing a schematic construction of a motor driving device in accordance with Embodiment 1 of the present invention.

FIGS. 2(a) and 2(b) are charts showing output phase voltages and output phase currents in a synchronous rectification control state and a synchronous rectification non-control state in Embodiment 1, respectively.

FIG. 3 is a graph showing a relationship between a torque command and motor rotation speed in Embodiment 1.

FIG. 4 is a diagram showing a schematic construction of a motor driving device in accordance with Embodiment 2 of the present invention.

FIG. 5 is a graph showing a relationship between a torque command and motor rotation speed in Embodiment 2.

FIG. 6 is a graph showing a relationship between a torque command and motor rotation speed in Embodiment 2.

FIG. 7 is a graph showing a relationship between a torque command and motor rotation speed in Embodiment 2.

FIG. 8 is a diagram showing a schematic construction of a motor driving device in accordance with Embodiment 3 of the present invention.

FIG. 9 is a diagram showing a construction example of a synchronous rectification control switching section in Embodiment 3.

FIG. 10 is a graph showing input/output characteristics of a current command signal generation section in Embodiment 3.

FIG. 11 is a graph showing a relationship between a torque command and motor rotation speed in Embodiment 3.

FIG. 12 is a diagram showing a schematic construction of a motor driving device in accordance with Embodiment 4 of the present invention.

FIG. 13 is a graph showing a relationship between a torque command and motor rotation speed in Embodiment 4.

FIG. 14 is a graph showing a relationship between a torque command and motor rotation speed in Embodiment 4.

FIG. 15 is a graph showing a relationship between a torque command and motor rotation speed in Embodiment 4.

FIG. 16 is a diagram showing a schematic construction of an optical disc device including a motor driving device according to the present invention.

FIG. 17 is a view showing a schematic overview of a large size motor module including a motor driving device according to the present invention.

FIG. 18 is a view showing a schematic overview of a small size motor module including a motor driving device according to the present invention.

FIG. 19 is a moving body (an electric automobile) including a motor driving device according to the present invention.

FIG. 20 is a diagram showing a schematic construction of a conventional motor driving device.

FIG. 21 is a diagram showing a schematic construction of a PWM control signal generating circuit

FIG. 22 is a chart showing PWM control signal generation.

FIG. 23 is a chart showing the phase relationship among a power transistor driving state, position detection signals generated by a position detection signal amplification section, and phase current waveforms of stator windings.

FIG. 24 is a chart showing waveforms for PWM control in motor drive by a minute torque command.

### INDEX OF REFERENCE NUMERALS

1 motor
1u, 1v, 1w stator winding
4 current command signal generation section
24 rotation speed signal generation section
25 control switching signal generation section
31 optical detection section
32 DSP (control switching signal generation section)
100 motor driving device

### BEST MODE FOR CARRYING OUT THE INVENTION

Embodiments of the present invention will be described below in detail with reference to the accompanying drawings.

### Embodiment 1

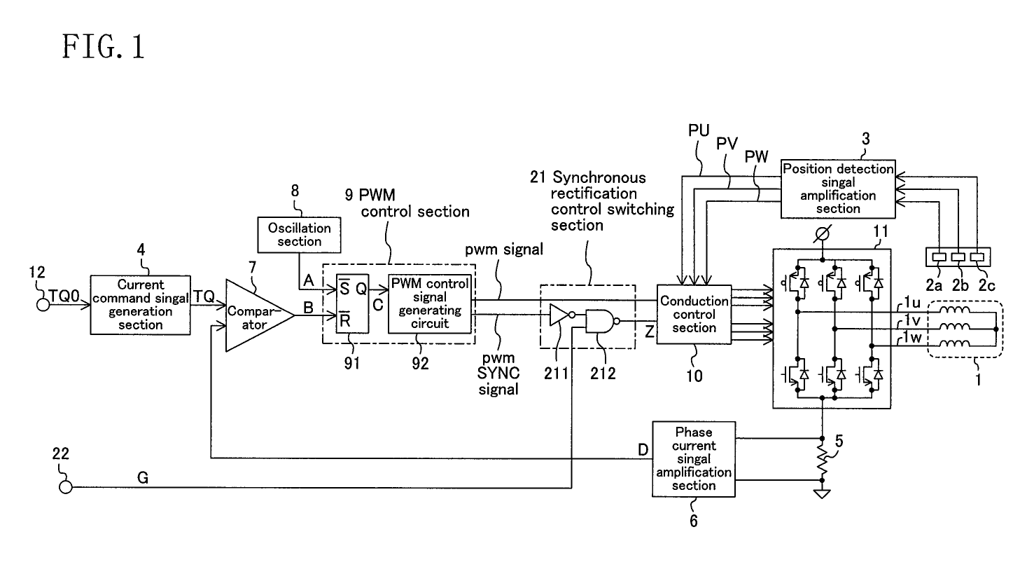

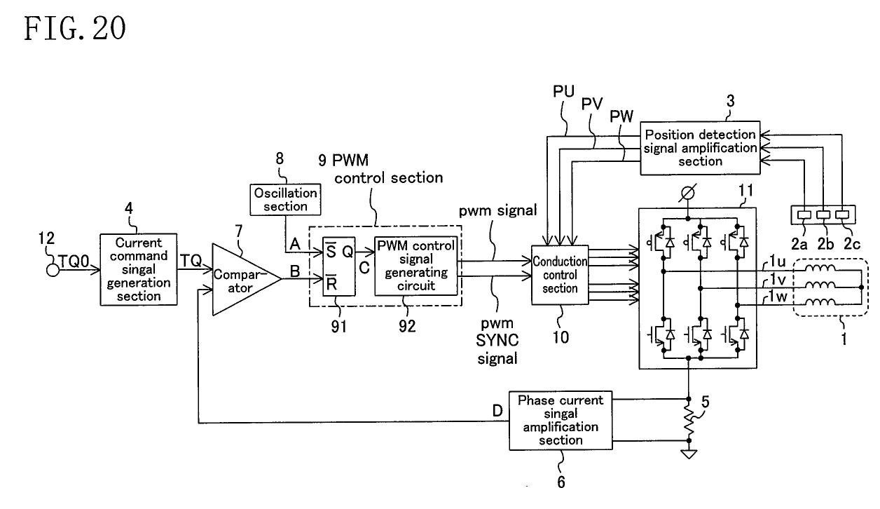

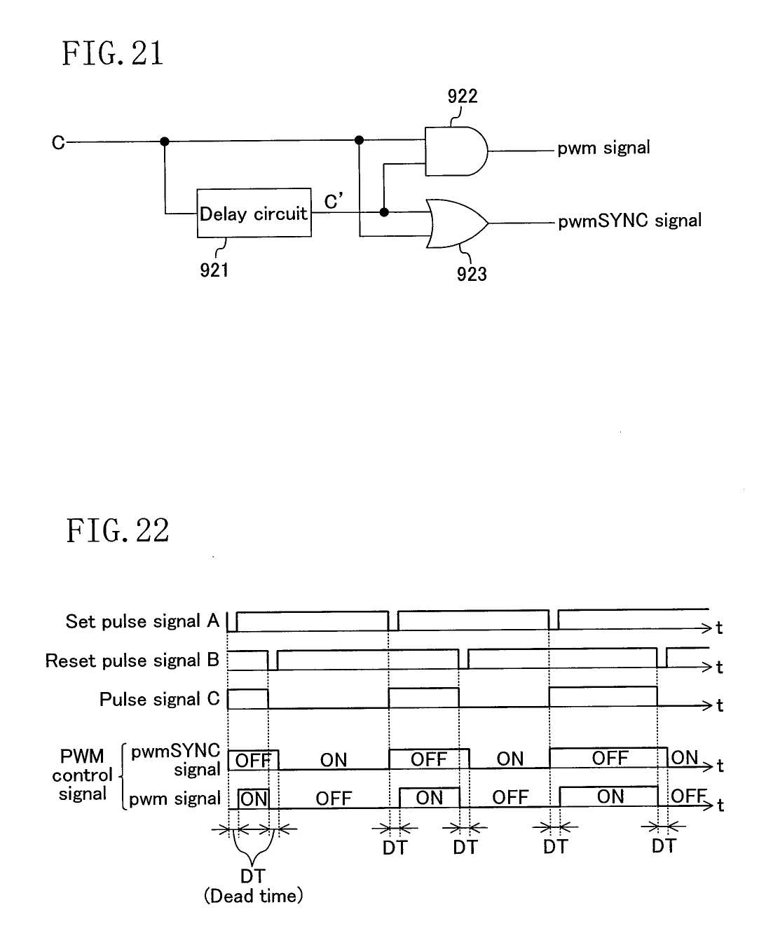

FIG. 1 is a diagram showing a schematic construction of a motor driving device in accordance with Embodiment 1 of the present invention. Herein, the same reference numerals are assigned to constitutional members corresponding to and having substantially the same functions as those in FIG. 20 showing the conventional example, and the same is applied to the following drawings, as well.

In FIG. 1, reference numeral 1 denotes a three-phase brushless DC motor (hereinafter referred to it as merely a motor), 1u, 1v, and 1w denote stator windings for three phases of the motor 1, 2a, 2b, and 2c denote three position sensors for detecting the position of a rotor of the motor 1, 3 denotes a position detection signal amplification section for amplifying position detection signals, 4 denote a current command signal generation section, 5 denotes a current detection resistor, 6 denotes a phase current signal amplification section, 7 denotes a comparator, 8 denotes an oscillation section, 9 denotes a PWM control section, 10 denotes a conduction control section, 11 denotes a power transistor section, 12 denotes a torque command input terminal, 21 denotes a synchronous rectification control switching section, and 22 denotes a control switching signal input terminal. The power transistor section 11 includes inside thereof three pairs of half bridges having output terminals connected to the stator windings 1u, 1v, 1w of the motor 1.

An operation of the thus constructed motor driving device will be described with reference to FIG. 1. First of all, the position sensors 2a, 2b, 2c detect the position of the rotor of the motor 1. The position detection signal amplification section 3 amplifies position detection signals output from the position sensors 2a, 2b, 2c. The current command signal generation section 4 is a circuit which receives a torque command signal TQ0 input to the torque command input terminal 12 and generates a command signal (a current command signal TQ) indicating the level of the current to be supplied to the stator windings 1u, 1v, 1w of the motor 1.

The current detection resistor 5 detects phase currents flowing in the stator windings 1u, 1v, 1w of the motor 1. The phase current signal amplification section 6 amplifies the phase currents detected by the current detection resistor 5 to generate a phase current signal D. The comparator 7 compares the current command signal TQ generated by the current command signal generation section 4 and the phase current signal D output from the phase current signal amplification section 6 and generates a comparison signal (a reset pulse signal B). The oscillation section 8 generates a set pulse signal A for periodically switching the power transistor section 11.

The PWM control section 9 starts conduction upon reception of the set pulse signal A from the oscillation section 8 and generates, upon reception of the reset pulse signal B from the comparator 7, two PWM control signals for stopping conduction. The two PWM control signals are synchronous rectification control signals, namely, a pwmSYNC signal for driving the source side transistors and a pwm signal for driving the sink side transistors of the power transistor section 11. Each of the two signals of the PWM control signals is provided with dead time for preventing a current from passing vertically through the source side transistors and the sink side transistors forming the output of the power transistor section 11.

The conduction control section 10 determines, upon reception of position detection signals PU, PV, PW output from the position detection signal amplification section 3, to which stator winding 1u, 1v, or 1w of the motor 1 power is to be supplied and generates, upon reception of the pwm signal generated by the PWM control section 9 and the pwmSYNC signal (signal Z) processed by the synchronous rectification control switching section 21, a conduction control signal for PWM driving the power transistor section 11. The synchronous rectification control switching section 21 controls the presence or absence of a mask for the synchronous rectification drive signal (the pwmSYNC signal) out of the two PWM control signals generated by the PWM control section 9 according to a control switching signal G input from the control switching signal input terminal 22. Namely, the synchronous rectification control section 21 allows the pwmSYNC signal to be output to the conduction control section 10 with the pwmSYNC signal unmasked or outputs an “H” signal to the conduction control section 10 with the pwmSYNC signal masked (cut off), thereby switching the state between a synchronous rectification control state and a synchronous rectification non-control state. The control switching signal G may be generated by a signal processing section (not shown), such as a DSP or the like on the basis of the rotation speed or the like of the motor 1.

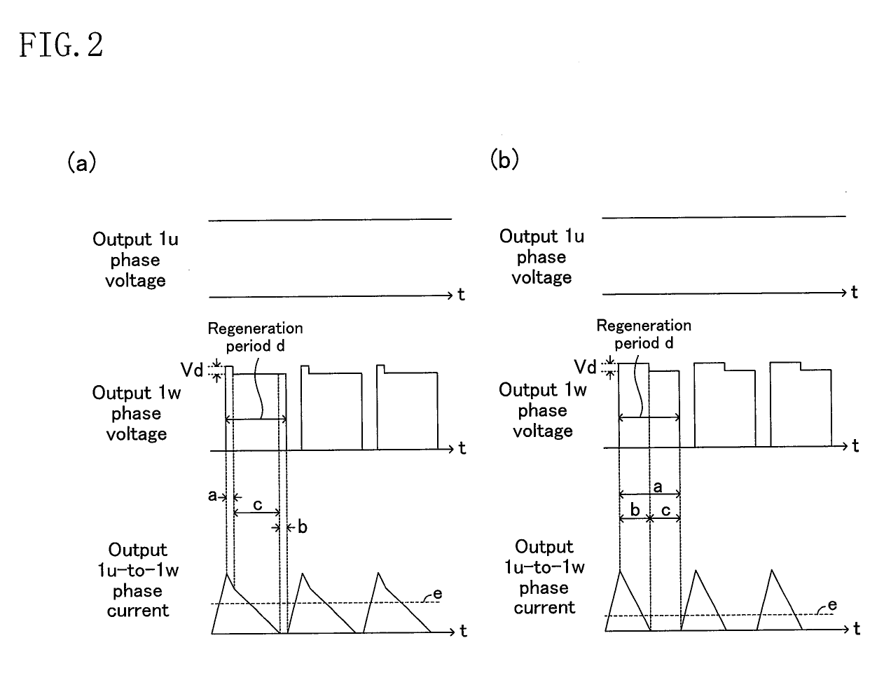

With reference to FIG. 1, FIG. 2(a), and FIG. 2(b), description will be given below of the logic that the setting to the synchronous rectification non-control state lowers the lowest rotation speed of the motor.

FIG. 2(a) shows a phase current and phase voltages in the stator windings of the motor in the synchronous rectification control state under the condition that the torque command signal is extremely small and PWM drive is performed at a minimum pulse width.

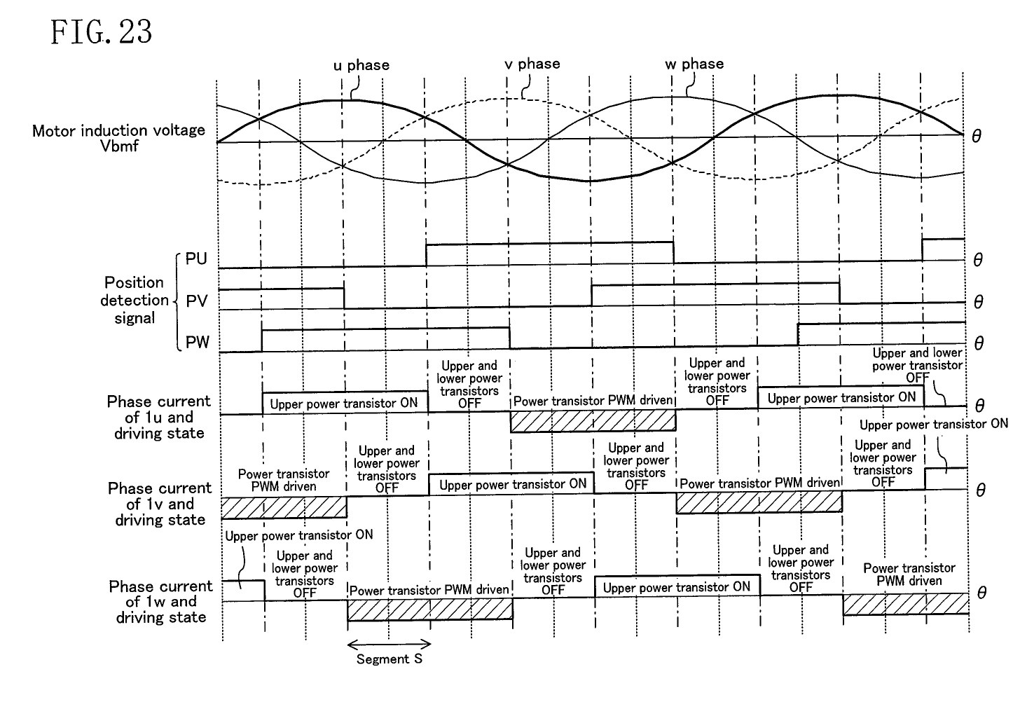

FIG. 2(a) shows the state where: the source side transistor of the power transistor section 11 for driving the phase of the stator winding 1u, of the motor 1 is turned ON; the sink side power transistor and the source side power transistor for driving the phase of 1w are PWM driven; the sink side power transistor and the source side power transistor for driving the phase of the other 1v are turned OFF; and power is supplied from the phase of the stator winding 1u, toward the phase of 1w. In this state, the conduction state is maintained in the phase segment indicated as a segment S in FIG. 23.

When a sink side transistor for each of the phases is turned ON, the phase voltage of the transistor is almost 0 V. While, when a source side transistor is turned ON, the phase voltage is equal to the source voltage to which the transistor is connected.

A period d in FIG. 2(a) is called a regeneration period, and an output 1u-to-1w phase current flowing in this period is called a regeneration current. In the aforementioned state, the regeneration current flows from the 1u, phase to the 1w phase. A period a in the regeneration period d is the dead time during which the regeneration current flows from a reflux diode connected in parallel to the source side power transistor for the 1w phase. During the period a, the phase voltage of the 1w phase is a voltage obtained by adding a forward diode voltage Vd to the source potential connected to the source side transistor. During the dead time as the period a, the reflux diode consumes energy, which is obtained by multiplying the regeneration current value and the forward diode voltage Vd in the period a, out of the energy in the motor 1 generating the regeneration current, with a result that the regeneration current is dampened comparatively abruptly.

Synchronous rectification control is performed during a period c in FIG. 2(a), so that the source side power transistor connected in parallel to the reflux diode is turned ON to cause the regeneration current flowing through the reflux diode during the period a to flow through the source side power transistor. The ON resistance of the power transistors is small enough to set the phase voltage of the 1w phase to be almost equal to the source potential to which the source side transistor is connected. Accordingly, the energy consumed in the source side power transistor is small to less reduce the energy of the motor for generating the regeneration current. As a result, the regeneration current is dampened more gently in the period c than in the period a.

While the dead time is provided also in a period b in FIG. 2(a), no regeneration current remains since the phase voltage of the 1w phase is equal to the source potential to which the source side transistor is connected. The broken line e in FIG. 2(a) indicates the average value of the output 1u-to-1w phase current flowing in the stator windings of the motor 1.

FIG. 2(b) shows the phase current and the phase voltages in the stator windings of the motor in the synchronous rectification non-control state under the same condition.

During the regeneration period d in FIG. 2(b), the source side transistor of the power transistor section 11 which always PWM drives the 1w phase is always turned OFF, and accordingly, the regeneration current always flows through the reflux diode connected in parallel to the source side power transistor.

As described above, since the energy of the motor 1 that generates the regeneration current is consumed as the energy that is generated by allowing the regeneration current to flow through the reflux diode, the regeneration current flowing through the reflux diode abruptly reduces in the period b in FIG. 2(b). In the period c in the regeneration period d, no regeneration current remains and flows. Accordingly, the phase voltage of the 1w phase is equal to the source potential to which the source side transistor is connected during the period C. The broken line e in FIG. 2(b) indicates the average value of the output 1u-to-1w phase current flowing in the stator windings of the motor 1.

As can be understood form FIG. 2(a) and FIG. 2(b), the average current value of the output 1u-to-1w phase current is lower in the synchronous rectification non-control state than in the synchronous rectification control state. Accordingly, the drive current of the motor 1 flowing in the stator windings of the motor 1 reduces to reduce the motor driving torque. As a result, the rotation speed of the motor 1 in the minimum pulse driving state can be reduced.

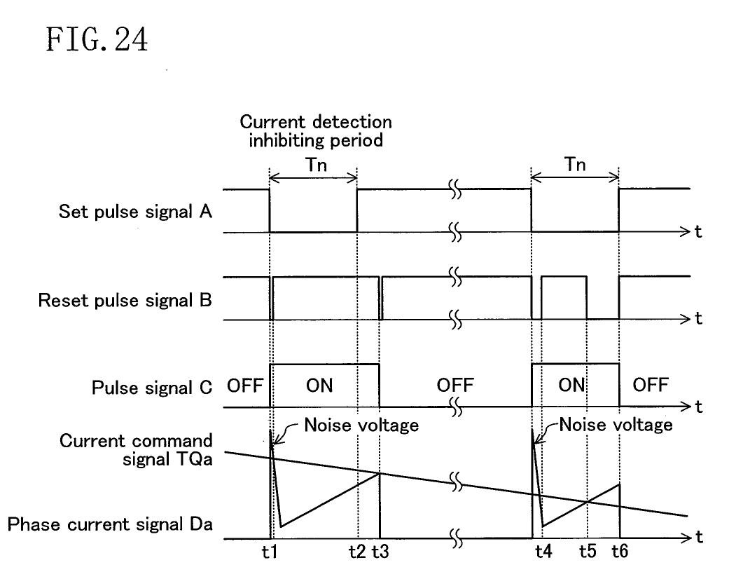

The synchronous rectification control switching section 21 is composed of a NOT circuit 211 and a NAND circuit 212 and switches, according to the signal state of the control switching signal G for the synchronous rectification, between the state allowing the synchronous rectification drive signal (the pwmSYNC signal) to be output to the conduction control section 10 with the pwmSYNC signal unmasked and the state outputting the “H” signal to the conduction control section 10 with the pwmSYNC signal masked (cut off). In FIG. 1, when the control switching signal G is “H,” the synchronous rectification drive signal (the pwmSYNC signal) is output directly to the conduction control section 10 to set the synchronous rectification control state. When the control switching signal G is “L,” the synchronous rectification drive signal (the pwmSYNC signal) is cut off by the synchronous rectification control switching section 21 and the “H” signal is output to the conduction control section 10 to set the synchronous rectification non-control state. This enables further lowering of the motor rotation speed which is restricted in the current detection inhibiting period Tn shown in FIG. 24. The NOT circuit 211 and the NAND circuit 212 are used for switching the synchronous rectification in Embodiment 1, but other components can realize the switching.

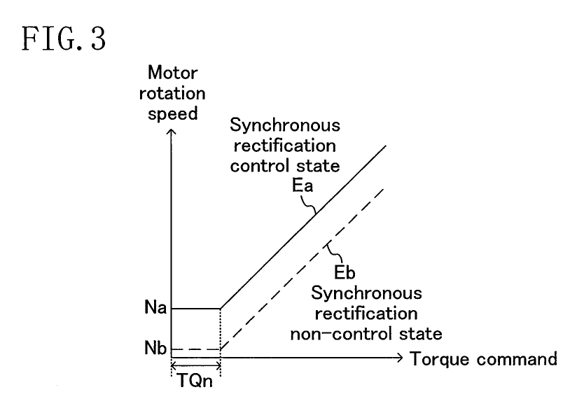

FIG. 3 shows the relationship between the torque command and the motor rotation speed in the steady rotation under the synchronous rectification control state or the synchronous rectification non-control state in Embodiment 1. In FIG. 3, reference Ea denotes the characteristics under the synchronous rectification control state while Eb denotes the characteristics under the synchronous rectification non-control state. Reference TQn in FIG. 3 denotes a torque command segment where the PWM drive is at the minimum pulse width. During the segment TQn, the motor rotation speed is not reduced even though the torque command is small, and the lowest rotation speeds are Na and Nb. The motor rotation speed with respect to the torque command is lower in the synchronous rectification non-control state Eb than in the synchronous rectification control state Ea.

In this way, when control on low speed rotation is desired, the synchronous rectification control switching signal invalidates the synchronous rectification to lower the lowest rotation speed, thereby increasing the low-speed rotation controllable range.

### Embodiment 2

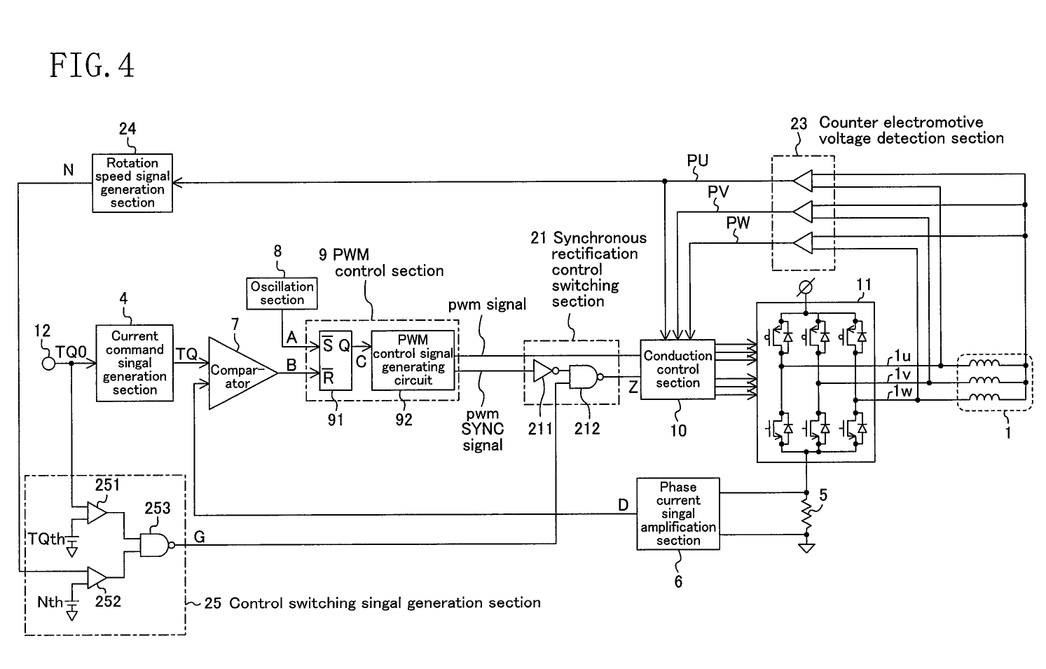

FIG. 4 is a view showing a schematic construction of a motor driving device in accordance with Embodiment 2 of the present invention. The motor driving device of Embodiment 2 is a motor driving device of sensorless type including a counter electromotive voltage detection section 23 in lieu of the position sensors 2a, 2b, 2c and the position detection signal amplification section 3 in the motor diving device of Embodiment 1 (see FIG. 1). The motor driving device of Embodiment 2 further includes a rotation speed signal generation section 24 and a control switching signal generation section 25 in lieu of the control switching signal input terminal 22 of the motor driving device of Embodiment 1.

The counter electromotive voltage detection section 23 detects counter electromotive voltages generated in the stator windings 1u, 1v, 1w of the motor 1 and generates counter electromotive voltage signals PU, PV, PW. The rotation speed signal generation section 24 receives any one of the counter electromotive voltage signals PU, PU, PW, for example, the signal PU and generates a rotation speed signal N indicating the rotation speed of the motor 1 according thereto.

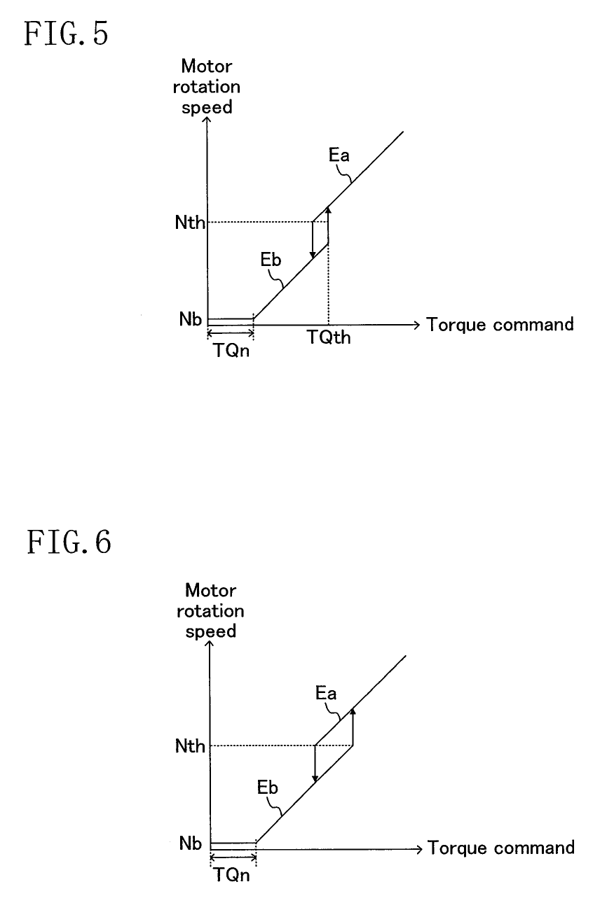

The control switching signal generation section 25 receives the torque command signal TQ0 and the rotation speed signal N and generates the control switching signal G on the basis thereof. Specifically, the control switching signal generation section 25 can be composed of a comparator 251 which compares the torque command signal TQ0 and a threshold value TQth thereof, a comparator 252 which compares the rotation speed signal N and a threshold value Nth thereof, and a NAND circuit 253 which calculates a logic product of the outputs of the two comparators and outputs the control switching signal G. For example, the comparator 251 is composed so as to output “H” when the torque command signal TQ0 is smaller than the threshold value TQth, and the comparator 252 is composed so as to output “H” when the rotation speed signal N is smaller than the threshold value Nth. Wherein, when both the torque command signal TQ0 and the rotation speed signal N are smaller than the respective threshold values, the control switching signal G is “L” to mask the pwm SYNCH signal. On the other hand, when at least one of the torque command signal TQ0 and the rotation speed signal N is smaller than the corresponding threshold value, the control switching signal G is “H” to unmask the pwmSYNC signal. FIG. 5 shows the relationship between the torque command and the motor rotation speed in the steady rotation in this case.

As described above, when the motor 1 is driven at low speed in Embodiment 2, the synchronous rectification control is invalidated automatically on the basis of the rotation speed of the motor 1 and the torque command to lower the lowest rotation speed, thereby extending the low-speed rotation controllable range.

It is possible that: the NAND circuit 253 is replaced by an AND circuit (not shown); the comparator 251 is set so as to output “H” when the torque command signal TQ0 is larger than the threshold value TQth; and the comparator 252 is set so as to output “H” when the rotation speed signal N is larger than the threshold value Nth. In this case, when both the torque command signal TQ0 and the rotation speed signal N are larger than the respective threshold values, the control switching signal G is “H” to unmask the pwmSYNC signal. On the other hand, when at least one of the torque command signal TQ0 and the rotation speed signal N is smaller than the corresponding threshold value, the control switching signal G is “L” to mask the pwmSYNC signal.

Alternatively, the NAND circuit 253 may be replaced by an SR flip-flop (not shown) appropriately set or reset according to the outputs of the comparators 251, 252. The control switching signal generation section 25 may have any one of various constructions other than the above examples.

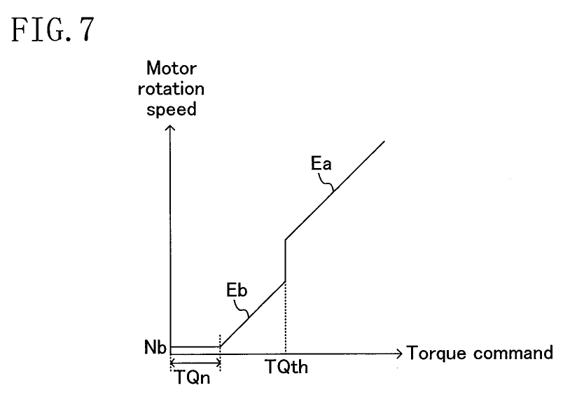

Further, the comparator 251 and the NAND circuit 253 may be omitted while the output of the comparator 252 is used as the control switching signal G. To do so, the comparator 252 is composed so as to output “L” when the rotation speed signal N is smaller than the threshold value Nth. FIG. 6 shows the relationship between the torque command and the motor rotation speed in the steady rotation in this case. Alternatively, the rotation speed signal generation section 24, the comparator 252, and the NAND circuit 253 may be omitted while the output of the comparator 251 is used as the control switching signal G. To do so, the comparator 251 is composed so as to output “L” when the torque command signal TQ0 is smaller than the threshold value TQth. FIG. 7 shows the relationship between the torque command and the motor rotation speed in the steady rotation in this case.

Alternatively, the current command signal TQ rather than the torque command signal TQ0 may be input to the comparator 251.

### Embodiment 3

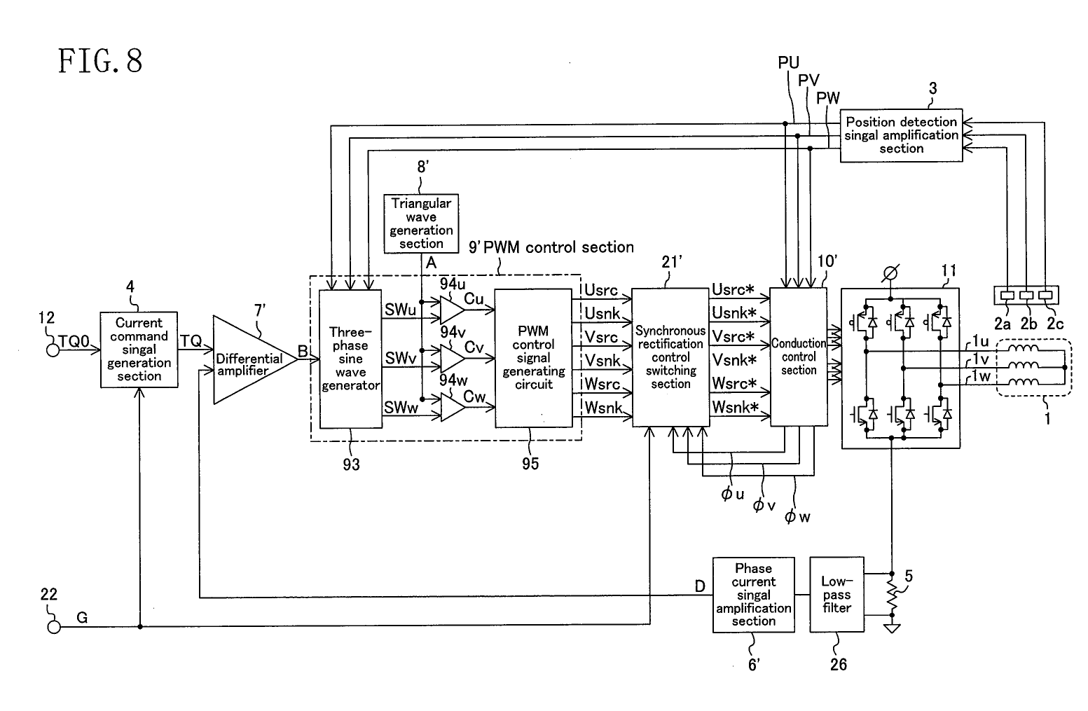

FIG. 8 is a diagram showing a schematic construction of a motor driving device in accordance with Embodiment 3 of the present invention, which is called of 120-degree conduction average current detection type. In FIG. 8, reference numeral 1 denotes a three-phase brushless DC motor (hereinafter referred to it as merely a motor), 1u, 1v, and 1w denote stator windings for three phases of the motor 1, 2a, 2b, and 2c denote three position sensors for detecting the position of a rotor of the motor 1, 3 denotes a position detection signal amplification section for amplifying the position detection signals, 4 denotes a current command signal generation section, 5 denotes a current detection resistor, 26 denotes a low-pass filter for cutting high frequency components of the voltages at the respective ends of the resistor 5, 6′ denotes a phase current signal amplification section which amplifies the output of the low-pass filter 26 and outputs the phase current signal D, 7′ denotes a differential amplifier for amplifying a difference between the current command signal TQ and the phase current signal D, 8′ denotes a triangle wave generation section, 9′ denotes a PWM control section, 10′ denotes a conduction control section, 11 denotes a power transistor section, 12 denotes a torque command input terminal, 21 denotes a synchronous rectification control switching section, and 22 denotes a control switching signal input terminal. The power transistor section 11 includes inside thereof three pairs of half bridges having output terminals connected to the stator windings 1u, 1v, 1w of the motor 1.

In the PWM control section 9′, a three-phase sine wave generator 93 generates sine waves SWu, SWv, SWw of the currents to be supplied to the stator windings 1u, 1v, 1w of the motor 1 upon reception of the position detection signals PU, PV, PW of the rotor output from the position detection signal amplification section 3. The amplitude of each sine wave is determined according to the output signal B of the differential amplifier 7′. Comparators 94u, 94v, 94w slice the sine waves SWu, SWv, SWw by a triangular wave A output from the triangular wave generation section 8′ and output pulse signals Cu, Cv, Cw, respectively. A PWM control signal generating circuit 95 generates signals for switching control on the power transistors of the power transistor section 11 upon reception of the pulse signals Cu, Cv, Cw. Specifically, a signal Usrc is a switching signal for the source side power transistor connected to the stator winding 1u of the motor 1, a signal Usnk is a switching signal for the sink side power transistor connected thereto. The same is applied to the other stator windings 1v, 1w of the motor 1.

Herein, in the average current detection scheme, either one of the signals Usrc or Usnk serves as the PWM drive signal for the stator winding 1u of the motor 1 while the other serves as the synchronous rectification drive signal therefor under the synchronous rectification control state. Which signal Usrc or Usnk serves as the PWM drive signal while the other serves as the synchronous rectification drive signal may change from moment to moment according to the driving state (conduction phase) of the stator winding 1u of the motor 1.

The conduction control section 10′ receives PWM control signals Usrc*, Usnk*, Vsrc*, Vsnk*, Wsrc*, Wsnk* output from the synchronous rectification control switching section 21′ and generates, by shifting the levels thereof, conduction control signals for PWM driving the power transistor section 11. The conduction control section 10′ also receives the position detection signals PU, PV, PW of the rotor output from the position detection signal amplification section 3 and generates phase signals φu, vφ, wφ indicating on which stator winding 1u, 1v, 1w of the motor 1 the PWM drive is being performed.

The synchronous rectification control switching section 21′ controls the presence or absence of the mask for the synchronous rectification drive signals out of the six PWM control signals generated by the PWM control section 9′ according to the control switching signal G input from the control switching signal input terminal 22. In other words, the synchronous rectification control switching section 21′ switches between the synchronous rectification control state and the synchronous rectification non-control state by outputting the synchronous rectification drive signals to the conduction control section 10′ with the synchronous rectification drive signals unmasked or outputting the “H” signal to the rectification control section 10′ with the synchronous rectification drive signals masked (cut off). The control switching signal G can be generated on the basis of the rotation speed of the motor 1 or the like by a signal processing section (not shown), such as a DSP or the like.

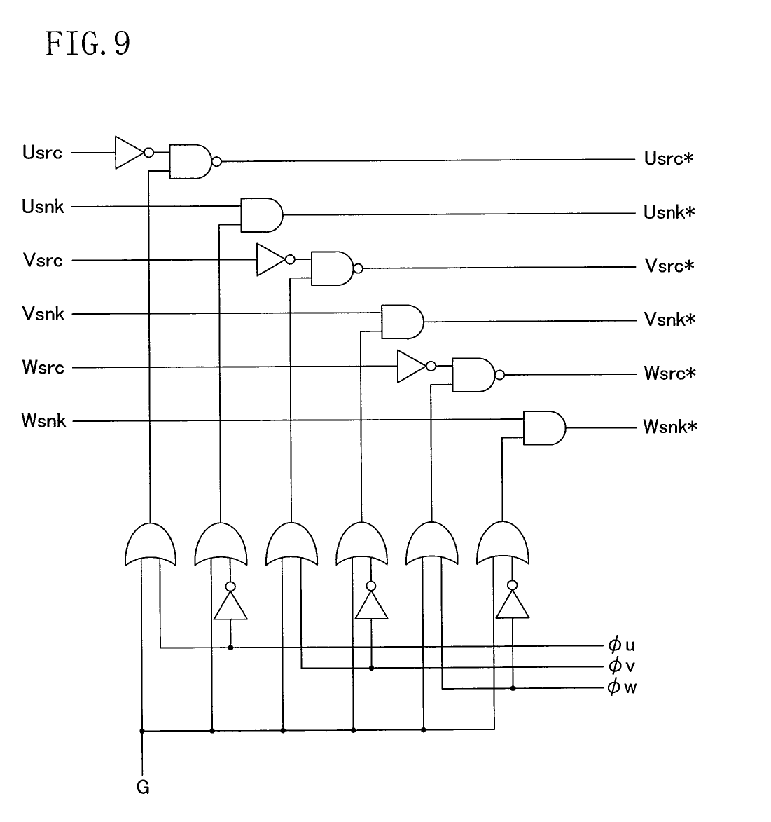

FIG. 9 shows a construction example of the synchronous rectification control switching section 21′. Herein, the phase signals φu, φv, φw are “H” when the source side power transistors of the power transistor section 11 which correspond to the stator windings 1u, 1v, 1w of the motor 1 are PWM driven.

Meanwhile, the current command signal generation section 4 is connected to the control switching signal input terminal 22 and is capable of changing, according to the control switching signal G, the gain (transfer gain) of the current command signal generation section 4 which is provided by dividing the current command signal TQ by the torque command signal. The current command signal generation section 4 has a function of setting the transmission gain thereof to be low when the synchronous rectification non-control state is set according to the control switching signal G.

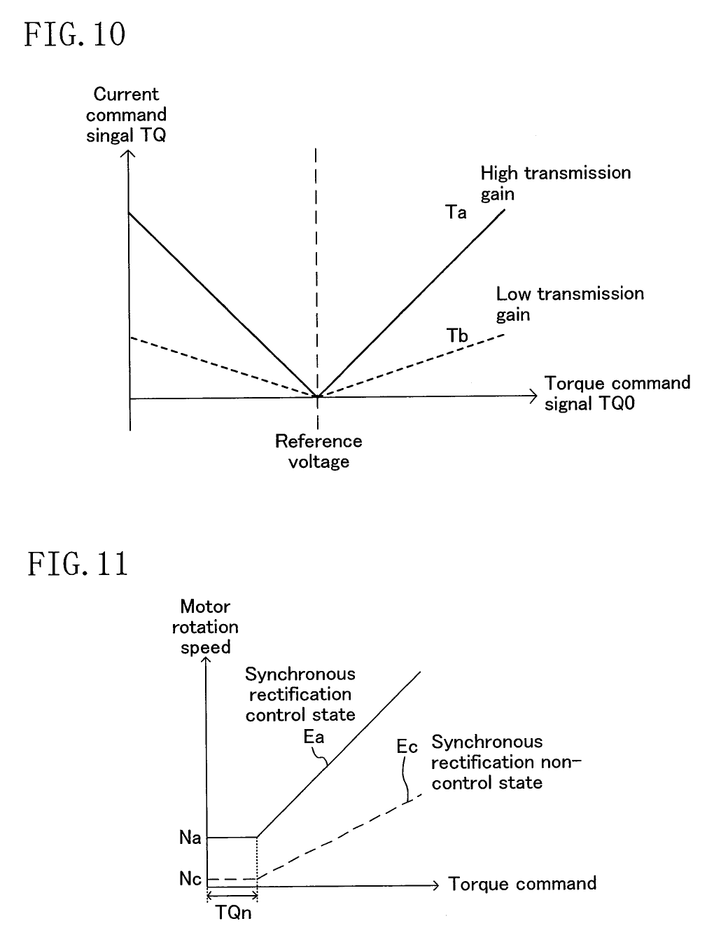

FIG. 10 shows the relationship between the torque command signal TQ0 and the current command signal TQ. In FIG. 10, Ta indicates the characteristics where the transmission gain of the current command signal generation section 4 is high while Tb indicates the characteristics where the transmission gain thereof is low.

According to the control switching signal G, the current command signal generation section 4 sets its transmission gain high in the synchronous rectification control state and sets its transmission gain low in the synchronous rectification non-control state, thereby attaining highly accurate control in the low-speed rotation range to lead to increased controllability.

FIG. 11 shows the relationship between the torque command signal and the motor rotation speed in the steady rotation of the motor under the synchronous rectification control state and the synchronous rectification non-control state in Embodiment 3. In FIG. 11, Ea indicates the characteristics under the synchronous rectification control state while Ec indicates the characteristics under the synchronous rectification non-control state. Reference TQn in FIG. 11 indicates a segment of the torque command where the PWM drive is at the minimum pulse width. During the segment TQn, even a small torque command leads to no reduction in motor rotation speed, and the lowest rotation speeds are Na and Nc.

Accordingly, the synchronous rectification control switching signal sets, when the low-speed rotation control is desired, invalidation of the synchronous rectification and the low-gain state of the amplitude of the current command signal, thereby extending the controllable range of the low-speed rotation and increasing the controllability.

### Embodiment 4

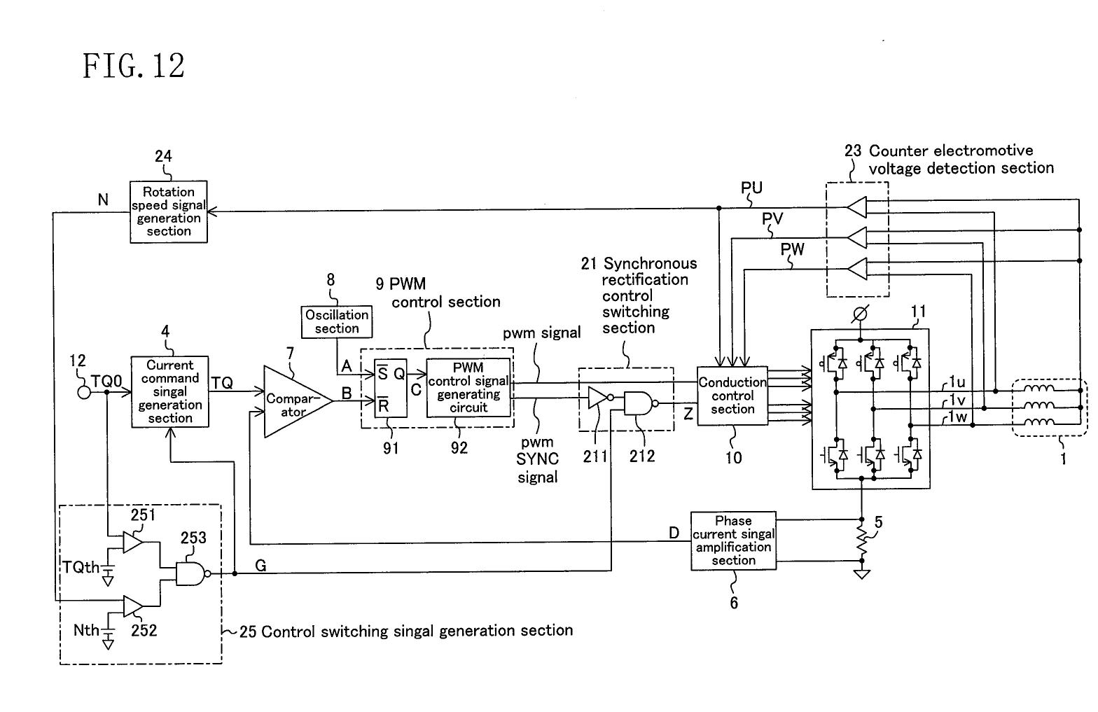

FIG. 12 is a diagram showing a schematic construction of a motor driving device in accordance with Embodiment 4 of the present invention. The motor driving device of Embodiment 4 is a motor driving device according to Embodiment 2 (see FIG. 4), wherein the transmission gain of the current command signal generation section 4 is set changeable according to the control switching signal G, as described above.

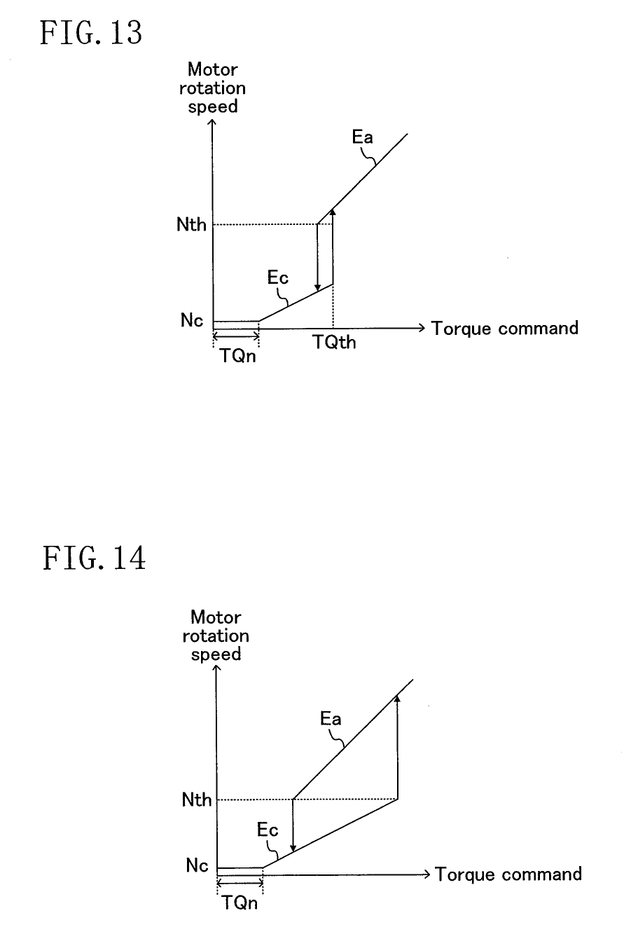

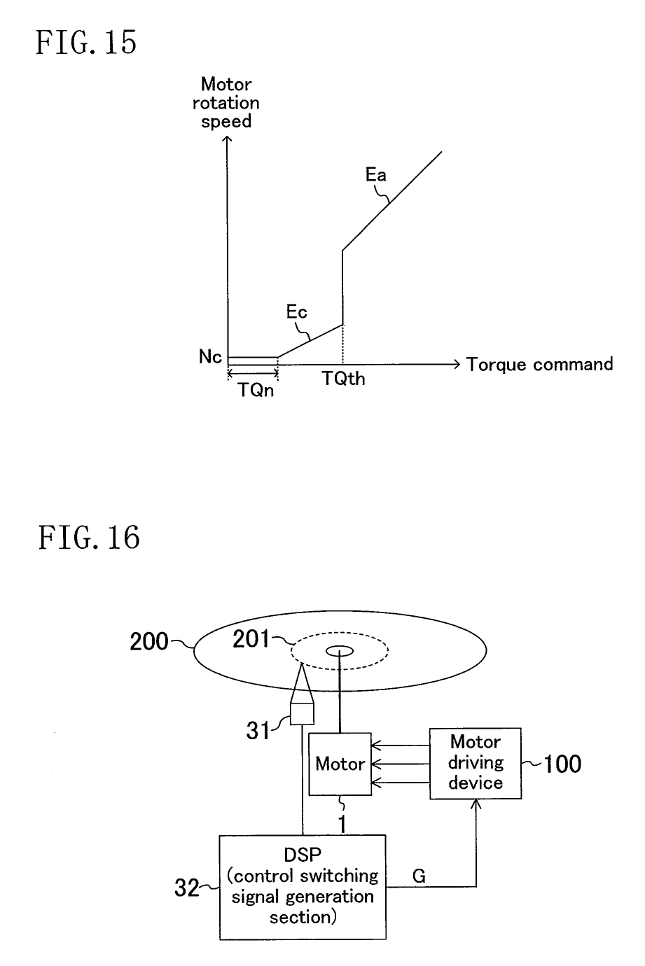

FIG. 13 shows the relationship between the torque command and the motor rotation speed in the steady rotation in Embodiment 4. FIG. 14 shows the relationship between the torque command and the motor rotation speed in the steady rotation where the output of the comparator 252 is used as the control switching signal G with the comparator 251 and the NAND circuit 253 omitted. FIG. 15 shows the relationship between the torque command and the motor rotation speed in the steady rotation where the output of the comparator 251 is used as the control switching signal G with the rotation speed signal generation section 24, the comparator 252, and the NAND circuit 253 omitted.

Thus, the present invention is applicable to almost all motor driving devices and motor driving methods for performing PWM control and synchronous rectification control irrespective of which type is employed, the phase current detection scheme or the scheme for detecting the position of the stator windings of the motor. In addition, a to-be-driven target of the motor driving device and the motor driving method of the present invention is not limited to the three-phase brushless DC motor and includes any other multi-phase motors.

(Applied Products)

FIG. 16 is a diagram showing a schematic construction of an optical disc device including a motor driving device according to the present invention. The optical disc device has a function of medium rendering. In FIG. 16, reference numeral 100 denotes the motor driving device according to the present invention, 1 denotes a motor (a spindle motor) to be driven thereby, 31 denotes an optical detection section for optically detecting marks 201 applied to an optical disc 200 set in the optical disc device, 32 denotes a DSP as the control switching signal generation section for calculating the rotation speed of the motor 1 and outputting the control switching signal G to the motor driving device 100 according to the thus calculated rotation speed. The marks 201 are trenches formed in the circumferential direction of the optical disc 20, for example. The DSP 32 detects the rotation speed of the motor 1 on the basis of the intervals of the marks 201 which are detected by the optical detection section 31.

In general, an optical disc must be driven and rotated at extremely low speed (around 40 RPM, for example) in an optical disc device having a function of medium rendering. With the use of the motor driving device according to the present invention, the spindle motor can be driven at extremely low speed rotation. The rotation speed of the motor is calculated on the basis an FG signal or the like in general, but accurate calculation of the motor rotation speed according to the FG signal is difficult in the extremely low speed rotation range. In view of this, when the optical disc to which the special marks for detecting the rotation speed are applied is used, optical reading of the marks leads to accurate calculation of the motor rotation speed even in the extremely low rotation range. The motor rotation speed may be detected and calculated by a rotary encoder (not shown) or the like rather than the optical detection section 31.

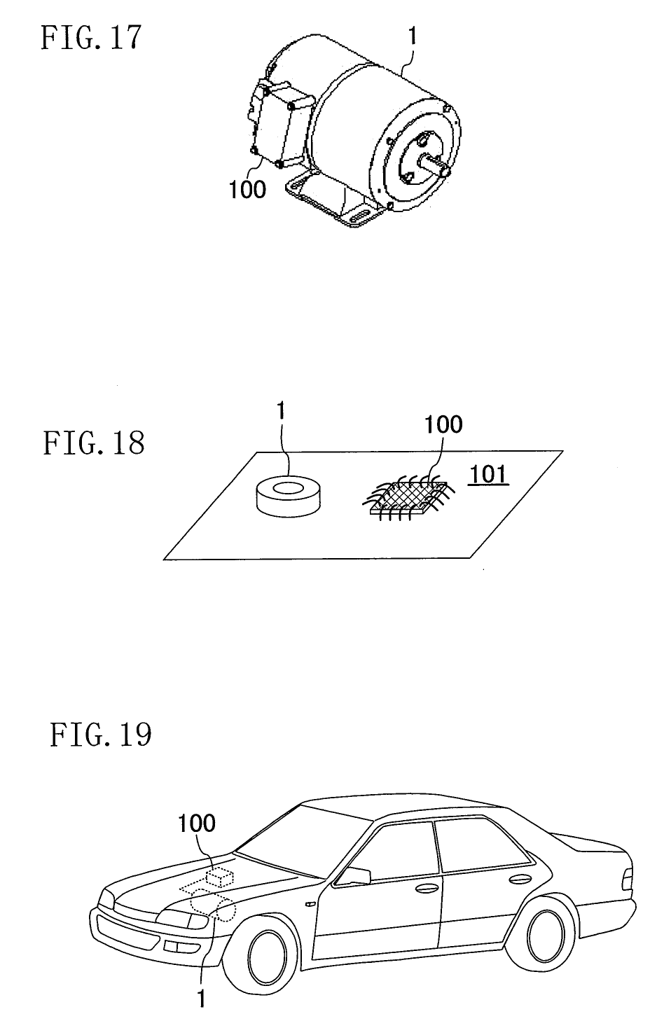

FIG. 17 is a view showing an overview of a large-size motor module including a motor driving device according to the present invention. FIG. 18 is a view showing an overview of a small-size motor module including a motor driving device according to the present invention. In each of FIG. 17 and FIG. 18, reference numeral 100 denotes the motor driving device according to the present invention, 1 denotes a motor to be driven thereby, and 101 is a substrate on which they are boarded. The motor module in FIG. 18 is suitable as a component of an electronic appliance, such as an optical disc device. Direct control on the motors by these modules can attain extremely low speed rotation drive even without using a gear.

FIG. 19 is a view showing an overview of a moving body (an electric automobile) including a motor driving device according to the present invention. In FIG. 19, reference numeral 100 denotes the motor driving device, 1 denotes a motor as a to-be-driven target thereof serving as a power source for the moving body. In the moving body, direct control on the motor without using a gear attains extremely low speed rotation drive. The motor diving apparatus and the motor driving method according to the present invention are applicable to general moving bodies including a motor as a power source, such as an electric bicycle, an electric railroad, and the like, besides the electric automobile.

### INDUSTRIAL APPLICABILITY

In the motor diving apparatus and the motor driving method in accordance with the present invention, the synchronous rectification control state is switched to the synchronous rectification non-control state when low-speed control of the motor is desired to reduce the amount of the current flowing into the stator windings of the motor, thereby attaining highly accurate low rotation control with rotation irregularity reduced in motor drive in a low speed range. Hence, the present invention is useful for stable motor drive control in low speed drive.

1. A motor driving device which generates a first PWM control signal for PWM driving each phase of stator windings of a motor and a second PWM control signal for synchronously rectifying the phases on the basis of a current command signal indicating a level of a current to be supplied to the motor and a phase current signal indicating a level of a current actually supplied to the motor and drives the motor according to the first and second PWM control signals, the motor driving device comprising:
a synchronous rectification control switching section for controlling the presence or absence of a mask for the second PWM control signal according to a provided control switching signal.

2. The motor driving device of claim 1, further comprising:
a rotation speed signal generation section for generating a rotation speed signal indicating a rotation speed of the motor; and
a control switching signal generation section for generating the control switching signal on the basis of the rotation speed signal.

3. The motor driving device of claim 1, further comprising:
a current command signal generation section for generating the current command signal from a torque command signal indicating a torque command to the motor; and
a control switching signal generation section for generating the control switching signal on the basis of one of the torque command signal and the current command signal.

4. The motor driving device of claim 3, further comprising:
a rotation speed signal generation section for generating a rotation speed signal indicating a rotation speed of the motor,
wherein the control switching signal generation section generates the control switching signal on the basis of the rotation signal.

5. The motor driving device of claim 1, further comprising:
a current command signal generation section for generating the current command signal by amplifying a torque command signal indicating a torque command to the motor,
wherein the current command signal generation section changes a gain for the amplification according to the control switching signal.

6. A motor driving method in which a first PWM control signal for PWM driving each phase of stator windings of a motor and a second PWM control signal for synchronously rectifying the phases are generated on the basis of a current command signal indicating a level of a current to be supplied to the motor and a phase current signal indicating a level of a current actually supplied to the motor for driving the motor according to the first and second PWM control signals, wherein
the second PWM control signal is masked when the motor is driven at low speed and is unmasked when the motor is driven at high speed.

7. The motor driving method of claim 6, wherein
the second PWM control signal is masked when a rotation speed of the motor is lower than a threshold value and is unmasked when the rotation speed of the motor is higher than the threshold value.

8. The motor driving method of claim 6, wherein
the second PWM control signal is masked when a torque commanded to the motor is lower than a threshold value and is unmasked when the torque is higher than the threshold value.

9. The motor driving method of claim 6, wherein
the second PWM control signal is masked when both a rotation speed of the motor and a torque commanded to the motor are lower than respective threshold values and is unmasked when at least one of the rotation speed and the torque is higher than the corresponding threshold value.

10. The motor driving method of claim 6, wherein
the second PWM control signal is unmasked when both a rotation speed of the motor and a torque commanded to the motor are higher than respective threshold values and is masked when at least one of the rotation speed and the torque is lower than the corresponding threshold value.

11. The motor driving method of claim 6, comprising the step of:
generating the current command signal by amplifying a torque command signal indicating a torque command to the motor; and
changing a gain for the amplification according to the presence or absence of a mask for the second PWM control signal.

12. An optical disc device comprising:
a spindle motor for driving and rotating an optical disc;
a motor driving device according to claim 1 for driving the spindle motor;
a rotation speed signal generation section for generating a rotation speed signal indicating a rotation speed of the spindle motor; and
a control switching signal generation section for generating the control switching signal on the basis of the rotation speed signal.

13. The optical disc device of claim 12, further comprising:
an optical detection section for optically detecting marks applied to the optical disc,
wherein the rotation speed signal generation section calculates the rotation speed of the spindle motor on the basis of intervals of the marks applied to the optical disc which are detected by the optical detection section.

14. A motor module comprising:
a motor; and
a motor driving device according to claim 1 for driving the motor.

15. A moving body using a motor as a power source, comprising:
a motor driving device according to claim 1 for driving the motor.
